(19) United States
(12) Patent Application Publication
(10) Pub. No.: US 2005/0201263 A1
(43) Pub. Date: Sep. 15, 2005

(54) Magneto-optical recording medium and a magneto-optical recording device thereof

(75) Inventor: Tetsuo Hosokawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 11/123,951

(22) Filed: May 6, 2005

Related U.S. Application Data
(63) Continuation of application No. PCT/JP03/02888, filed on Mar. 12, 2003.

(51) Int. Cl. G11B 7/24

(52) U.S. Cl. 369/275.4; 369/94; 369/283

(57) ABSTRACT

A magneto-optical recording medium where a magneto-optical recording film is formed on optical phase pits formed on a substrate can be optically regenerated both the optical phase pit signals and the signals of the recording film formed thereon. The magneto-optical recording medium satisfies following condition,
344X−8.12≧Y and Y≧286X−0.7
0.080≦X≦0.124 and 16≦Y≦30 where X (λ) is the optical depth of the phase pits formed on the substrate and Y (%) is the modulation degree of the phase pits when irradiated with an optical beam in the polarization direction perpendicular to the tracks of the optical recording medium. According to the above condition, a magneto-optical recording medium, which can suppress the jitter of MO signal and phase pit signal within less than ten percents without generating cracks with a sufficient repeat recording durability, is obtained.

### CROSS-REFERENCE TO RELATED APPLICATIONS

This application is a continuation of international application PCT/JP2003/002888, filed on Mar. 12, 2003.

### TECHNICAL FIELD

The present invention relates to a magneto-optical recording medium which has both functions of ROM (Read Only Memory) by optical phase pits formed on a substrate and RAM (Random Access Memory) by an magneto-optical recording film, and a magneto-optical recording device thereof, and more particularly to a magneto-optical recording medium for regenerating both the ROM and RAM well and a magneto-optical recording device thereof.

### BACKGROUND ART

FIG. 21 is a plan view depicting a conventional magneto-optical disk conforming to ISO standards, FIG. 22 is an enlarged view depicting the user area thereof, FIG. 23 is a cross-sectional view thereof, and FIG. 24 is a relational diagram depicting the phase pits thereof and an MO signal. As FIG. 21 shows, the magneto-optical disk 70 is comprised of a read in area 71, read out area 72 and user area 73. The read in area 71 and the read out area 72 are ROM areas comprised of phase pits formed by bumps on the polycarbonate substrate. The depths of the phase pits of the ROM area are set such that the light intensity modulation during regeneration becomes the maximum. The area between the read in area 71 and the read out area 72 is the user area 73, which is a RAM area where the user can freely record information.

As the enlarged view of the user area 73 in FIG. 22 shows, the land 75 between the grooves 74, to be the tracking guides, has phase pits 78 to be a header section 76 and user data section 77. The user data section 77 is a flat land 75 between the grooves 74, and is recorded as magneto-optical signals.

To read the magneto-optical signals, when a weak laser beam is emitted there, the polarization plane of the laser beam changes depending on the magnetization direction of the recording layer by the polar Kerr effect, and the presence of a signal is judged by the intensity of the polarization component of the reflected light at this time. By this, the RAM information can be read.

Research and development to utilize such features of this magneto-optical disk memory have been advancing. For example, in Japanese Patent Application Laid-open No. H6-202820, a concurrent ROM-RAM optical disk which can regenerate ROM and RAM simultaneously was disclosed.

Such a magneto-optical recording medium 74 which can regenerate ROM and RAM simultaneously has a cross-sectional structure in the radius direction shown in FIG. 23, and is comprised, for example, of a substrate 74A made of polycarbonate, dielectric film 74B, magneto-optical recording film 74C made of TbFeCo, dielectric film 74D, Al film 74E, and UV hardening film 74F as a protective layer, which are layered.

In this magneto-optical recording medium with such a structure, as shown in FIGS. 23 and 24, the ROM information is fixedly recorded by the phase pits PP on the substrate 74A, and the RAM information OMM is recorded on the phase pit PP string by magneto-optical recording. FIG. 24 is the cross-section in the A-B line in the radius direction in FIG. 23. In the example shown in FIG. 24, the phase pits PP become the tracking guides, so the grooves 74 shown in FIG. 22 are not provided.

In this optical recording medium, many problems exist to simultaneously regenerate ROM information comprised of phase pits PP and RAM information comprised of magneto-optical recording OMM.

First in order to stably regenerate ROM information along with RAM information, the light intensity modulation which occurs when ROM information is read becomes a cause of noise when RAM information is regenerated. For this the present applicant proposed to decrease the light intensity modulation noise by the negative feedback of the light intensity modulation signals, generated when ROM information is read, to the laser for read driving in the international application PCT/JP 02/00159 (international application filing date Jan. 11, 2002). However a noise reduction effect is not sufficient with only this if the light intensity modulation degree of the ROM information is high.

Secondly the feedback control of the laser intensity at high-speed is difficult.

### SUMMARY OF THE INVENTION

With the foregoing in view, it is an object of the present invention to provide a magneto-optical recording medium for stably regenerating the ROM information comprised of phase pits and the RAM information simultaneously, and to provide a magneto-optical recording device thereof.

It is another object of the present invention to provide a magneto-optical recording medium for suppressing the jitter of the regeneration signals of the ROM information and RAM information within a predetermined range, and a magneto-optical recording device thereof.

It is still another object of the present invention to provide a magneto-optical recording medium for suppressing the jitter of the regeneration signals of the ROM information and RAM information within a predetermined range without generating cracks with a sufficient repeat recording durability.

To achieve these objects, a magneto-optical recording medium and its device of the present invention has a magneto-optical recording medium where a recording film is formed on optical phase pits formed on a substrate so that both the optical phase pit signals and the signals of the recording film can be regenerated by light, that satisfy
344X−8.12≧Y and Y≧286X−10.7
0.080≦X≦0.124 and 16≦Y≦30
where X (λ) is the optical depth of the phase pits formed on the substrate and Y (%) is the modulation degree of the phase pits when irradiated with an optical beam in the polarization direction perpendicular to the tracks of the optical recording medium.

According to the present invention, a magneto-optical recording medium, which can suppress the jitter of MO signal and phase pit signal within less than ten percents without generating cracks with a sufficient repeat recording durability, is obtained.

Also according to the present invention, it is preferable that the magneto-optical recording medium satisfy the following condition.
344X−8.12≧Y and Y≧286X−10.7
0.080≦X≦0.124 and 19≦Y≦26

According to the present invention, it can suppress the jitter of MO signal and phase pit signal within less than eight percents which has more margin.

Also according to the present invention, it is preferable that the magneto-optical recording film has a dielectric thin film and a recording film, and the dielectric thin film comprised of SiN. So, it is realized to obtain the magneto-optical recording medium having improving durability.

### BRIEF DESCRIPTION OF THE DRAWINGS

FIG. 1 is a cross-sectional view depicting the magneto-optical recording medium to be used for an embodiment of the present invention;

FIG. 2 is a perspective view depicting the recording status of the ROM information and RAM information in the magneto-optical recording medium in FIG. 1;

FIG. 3 is a diagram depicting the configuration of the sputtering device for manufacturing the magneto-optical recording medium in FIG. 1;

FIG. 4 is a graph depicting the relationship between the Ar flow rate and pressure in the chamber in FIG. 3;

FIG. 5 is a diagram depicting the modulation degree of the phase pits which is the evaluation target of the magneto-optical recording medium of the present invention;

FIG. 6 is a graph depicting the signal jitter which is the evaluation target of the magneto-optical recording medium of the present invention;

FIG. 7 is a graph depicting the relationship between the Ar pressure and modulation degree according to the present invention;

FIG. 8 is a graph depicting the relationship between the modulation degree and jitter of the ROM signal and RAM signal according to the present invention;

FIG. 9 is a graph depicting the relationship between the Ar pressure and signal jitter according to the present invention;

FIG. 10 is a table showing the crack observation result by heat shock testing according to the present invention;

FIG. 11 is a graph depicting the optical phase pit depth and modulation degree according to the present invention;

FIG. 12 is a graph depicting the setup range of the optical phase pit depth and modulation degree according to the present invention;

FIG. 13 is a cross-sectional view depicting the magneto-optical recording medium to be used for another embodiment of the present invention;

FIG. 14 is a block diagram of a magneto-optical recording device according to one embodiment invention of this invention;

FIG. 15 is a detailed diagram of a optical system in an optical pick up of FIG. 14;

FIG. 16 is a part detailed block of FIG. 14;

FIG. 17 is an arrangement diagram of a photo detector in FIGS. 15 and 16;

FIG. 18 is a relationship diagram between an output of a photo detector in FIG. 17, focus error (FES) detection, track error (TES) detection, MO signal and a LD feedback signal;

FIG. 19 is a combination diagram between ROM and RAM detections of each reproducing mode and recording mode in a main controller of FIGS. 14 and 16;

FIG. 20 is a block diagram depicting the magneto-optical recording device according to another embodiment of the present invention;

FIG. 21 is a plan view depicting a conventional magneto-optical recording medium;

FIG. 22 is a diagram depicting the user area in FIG. 21;

FIG. 23 is a cross-sectional view depicting the ROM-RAM magneto-optical disk memory shown in FIG. 22; and

FIG. 24 is a plan view depicting the recording status of the ROM information and RAM information in the magneto-optical recording medium with the structure in FIG. 23.

### PREFERRED EMBODIMENTS OF THE INVENTION

Embodiments of the present invention will now be described in the sequence of the magneto-optical recording medium, the magneto-optical recording device and other embodiments.

Magneto-Optical Recording Medium

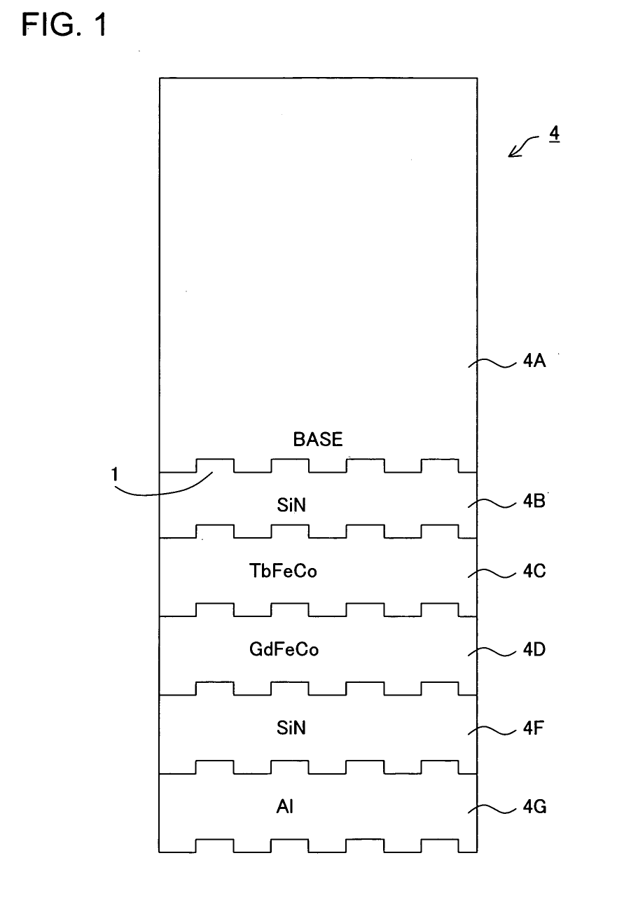

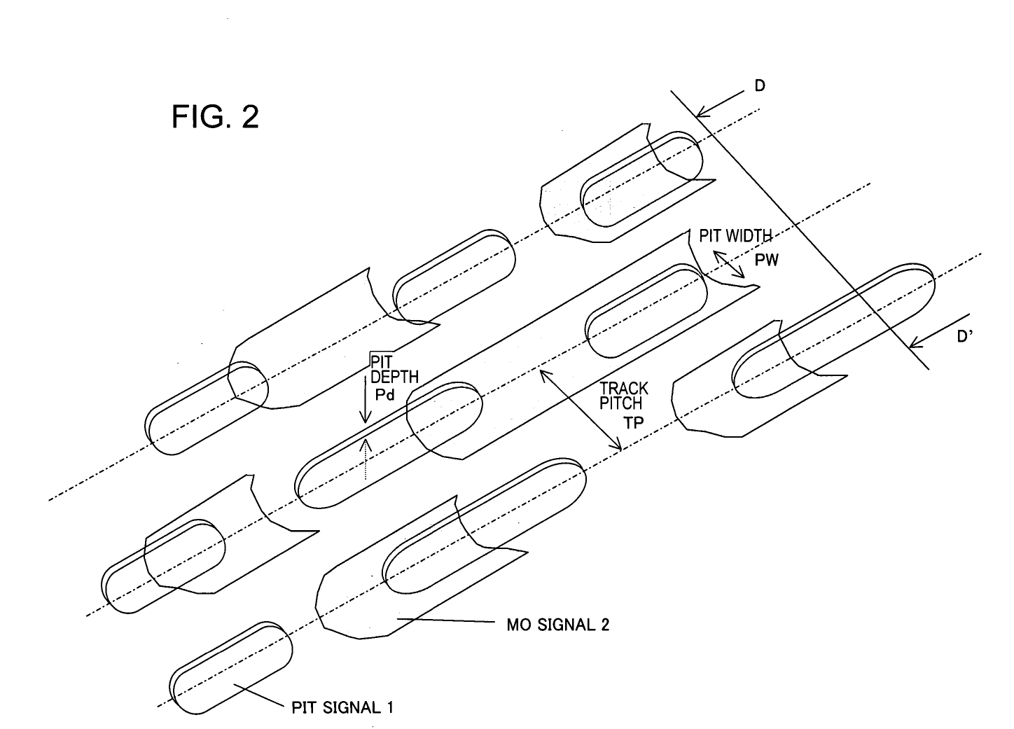

FIG. 1 is a cross-sectional view depicting the concurrent magneto-optical recording medium according to an embodiment of the present invention, and FIG. 2 is a diagram depicting the relationship of the ROM signal and the RAM signal thereof.

As FIG. 1 shows, in order to provide the functions of ROM and RAM in the user area, the magneto-optical disk 4 is comprised of a first dielectric layer 4B made from silicon nitride (SiN) or tantalum oxide, two layers of magneto-optical recording layers 4C and 4D of which the main component is an amorphous alloy of a rare earth element (Tb, Dy, Gd) and transition metals (FeCo), such as TbFeCo and GdFeCo, a second dielectric layer 4F made from a material that is the same as or different from that of the first dielectric layer 4B, a reflection layer 4G made from such a metal as Al and Au, and a protective coat layer using ultraviolet hardening resin, which are formed on a polycarbonate substrate 4A on which the phase pits 1 are formed.

As FIG. 1 and FIG. 2 show, the ROM function is provided by the phase pits 1 which are created as bumps on the disk 4, and the RAM function is provided by the magneto-optical recording layers 4C and 4D. To record on the magneto-optical recording layers 4C and 4D, a laser beam is applied onto the magneto-optical recording layers 4C and 4D to assist in the reversal of magnetization, the magneto-optical (MO) signals 2 are recorded by reversing the direction of magnetization corresponding to the signal magnetic field. By this, recording the RAM information is possible.

To read the recorded information of the magneto-optical recording layers 4C and 4D, a weak laser beam is applied onto the recording layers 4C and 4D so that the polarization plane of the laser beam is changed according to the magnetization direction of the recording layers 4C and 4D by the polar Kerr effect, and the presence of signals is judged by the intensity of the polarization component of the reflected light at this time. By this, the RAM information can be read. In this reading, the reflected light is modulated by the phase pits PP constituting ROM, so the ROM information can be read simultaneously.

In other words, ROM and RAM can be simultaneously regenerated by one optical pickup, and when a magnetic field modulation type magneto-optical recording is used, writing to RAM and regenerating ROM can be executed simultaneously.

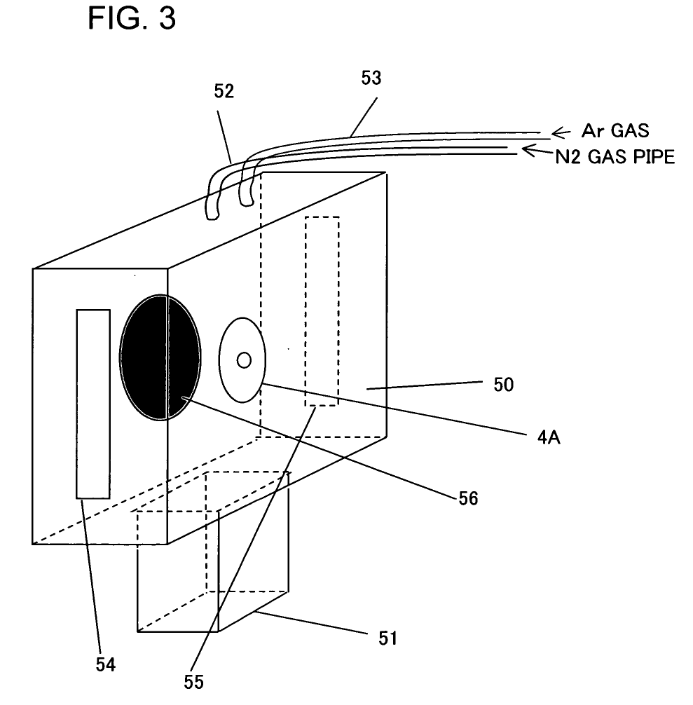

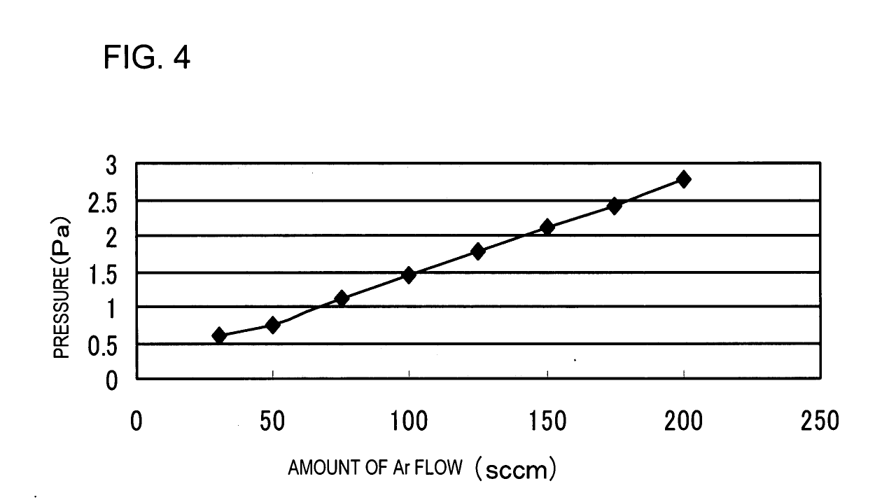

FIG. 3 is a diagram depicting the sputtering device for manufacturing the concurrent magneto-optical medium in FIG. 1, FIG. 4 is a graph depicting the relationship of the Ar flow rate and the pressure in the chamber thereof.

First the manufacturing step of the magneto-optical disk with the cross-sectional configuration shown in FIG. 1 will be described. Five polycarbonate substrates 4A with different groove depths (optical pit depths) Pd, which are formed with an EFM modulation of track pitch Tp=1.6 μm, pit width Pw=0.40 μm and the shortest pit length=0.832 μm, are prepared according to FIG. 2.

In other words, five polycarbonate substrates 4A of which the optical phase pit depth Pd (λ) is 0.070, 0.080, 0.105, 0.124 and 0.136 are prepared. Here the pit depth is changed by the resist coating film thickness in the stamper manufacturing process of the stamper for forming the phase pits on the substrate 4A.

The substrate 4A is entered in the sputtering device 50 including a plural of sputtering room of the reached vacuums of less than 5×e−5 (Pascal). The substrate 4A is transported to the first chamber 50 attached Si target 56, and the chamber 50 is introduced Ar gas and N2 gas and is applied 3 kilo watt DC power to deposit undercoat(UC) silicon nitride (SiN) layer 4B by reactive sputtering.

As FIG. 3 shows, the sputtering device vacuums inside the sputtering chamber 50 at about 5×e−5 (Pascal), for example, using such a vacuum pump 51 as a cryopump. Then the substrate transport gates 54 and 55 are opened and the substrate 4A is inserted from the adjacent chamber. Ar gas and N₂ gas, which are inactive gases, are introduced into the sputtering chamber 50 via the Ar gas pipe 53 and the N₂ gas pipe 52. At this time the gas pressure in the sputtering chamber 50 is adjusted by changing the flow rate of the Ar gas.

As FIG. 4 shows, the relationship between the Ar gas flow rate and the pressure differs depending on the size and shape of the sputtering chamber 50, but the relationship is roughly proportional. To the target 56, such as Si, power is supplied from a DC power supply, which is not illustrated. Plasma is generated by the supplied power and Ar gas, Si is scattered from the Si target 56, and is deposited on the substrate 4A while reacting with the N₂ gas, and an SiN layer 4B is formed on the substrate 4A as a result.

Here a plurality of samples (a total of 7 samples, as described later), which has the SiN undercoat layer, were created by changing the gas pressure in the chamber 50 by changing the Ar gas flow rate. The gas flow rate was changed in a 30 sccm (quantity that flows per minute) to a 200 sccm range. The film deposition time was adjusted so that the thickness of the under coat SiN layer 4B becomes 80 nm.

Then the substrate 4A is moved to the another chamber, where the alloy target TbFeCo is discharged while changing the power supply ratio, and the recording layer 4C with a 30 nm thickness made from Tb₂₂ (Fe₈₈Co₁₂) 78 is deposited. Then the Gd₁₉ (Fe₈₈Co₂₀) 81 recording auxiliary layer 4D with a 4 nm film thickness is added to the Tb₂₂ (Fe₈₈Co₁₂) 78 recording layer 4C with a 30 nm film thickness, as shown in FIG. 1.

Then the substrate 4A is moved to the first chamber 50, and the over coat SiN layer 4E with a 5 nm thickness and a 50 nm Al layer 4G is deposited as a result. After the Al layer is deposited, the ultraviolet hardening resin is spin-coated thereon to form the protective film, and the magneto-optical recording medium 4 shown in FIG. 1 is created.

The modulation degree and the jitter, when the ROM of the 35 samples with this configuration (magneto-optical disks formed on the substrates with five types of optical pit depths using seven different gas pressures) is regenerated, are measured as the evaluation target.

These samples are set in the recording/regeneration device (MO tester: LM 530C made by Shibasoku Ltd.) with a 1.08 μm (1/e 2) beam diameter, a 650 nm wave length and 0.55 NA (Numerical Aperture), and are rotated at a 4.8 m/s line speed

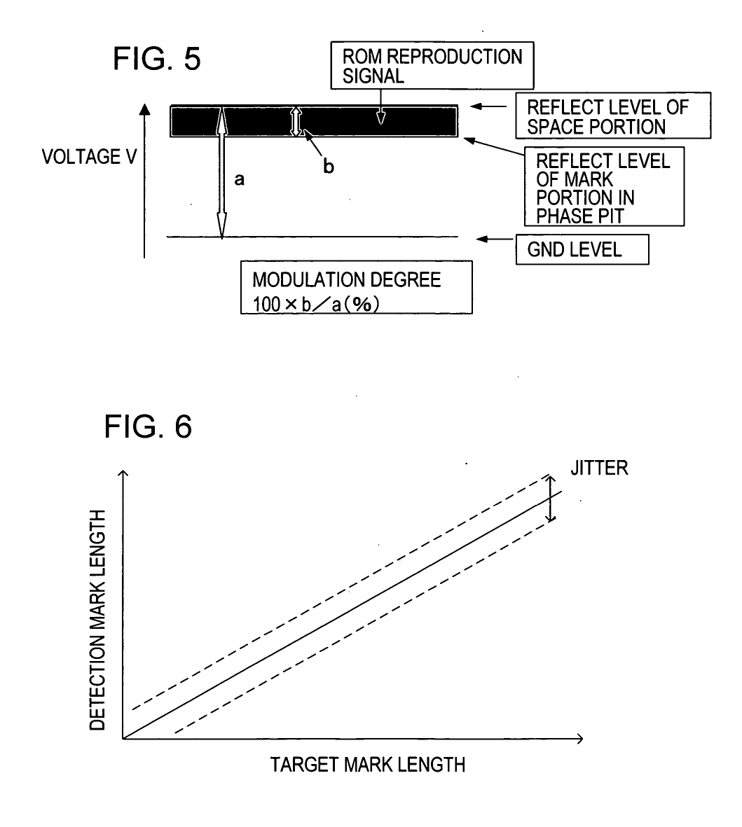

Phase pits (the same pattern as a compact disk) for the EFM modulation of which the shortest mark is 0.832 μm are formed on the ROM section 42 of these samples. The modulation degree is measured as shown in FIG. 5 by recording data under the following recording conditions and regenerating it under the following regeneration conditions. That is, an EFM random pattern is recorded by magnetic field modulation on the ROM section 42 with a Pw=6.5 mW recording laser power and a DC emission with the shortest mark length, 0.832 μm.

The regenerated light is at regeneration power Pr=1.5 mW and no regeneration magnetic field, and the polarization direction is in a perpendicular direction with respect to the tracks. ROM regeneration waveforms are measured by an oscilloscope, and on the tracks of the medium shown in FIG. 2, the reflection level (space section reflection level in FIG. 5) when the regeneration beam is applied onto the sections where the phase pits 1 do not exist (space sections), and the regeneration output level (mark section reflection level in FIG. 5) when the regeneration beam is applied onto the section where the phase pits 1 exist (mark sections), were measured. As FIG. 5 shows, the modulation degree is defined as 100×b/a(%).

For the jitter, ROM jitter by the phase pits and MO regeneration jitter on the ROM were measured. The jitter shown in FIG. 6 was measured by a time interval analyzer during “data to data” time. The jitter is the size of the error of the detected mark length with respect to the target mark length, and if the jitter is large, error correction becomes impossible, and a regeneration error occurs.

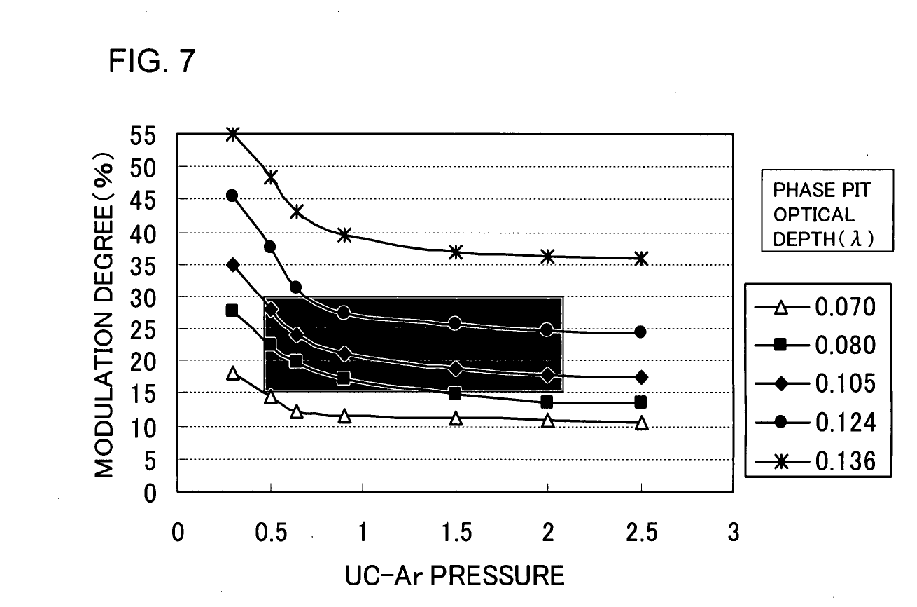

FIG. 7 shows the dependency of the modulation degree on the Ar pressure when an SiN undercoat layer is formed for each substrate (five types of substrates) of which the depth of the phase pits is different. As FIG. 7 shows, the modulation degree can be adjusted to be high at a low Ar pressure side, and low at a high Ar pressure side by increasing the Ar pressure when the SiN undercoat layer is formed.

When the Ar pressure is 1.5 Pa or more, there is little change in the modulation degree, and it stabilizes. In this way, by changing the setting of the Ar pressure of the SiN undercoat layer, the modulation degree can be adjusted. This tendency of the change is roughly the same regardless the optical depth of the phase pits of the substrate. Here the optical depth of the phase pits was measured by AFM (Atomic Force Microscope) measurement equipment after the substrate is molded.

The reason why the modulation degree of the phase pits of the magneto-optical disk is changed depending on the Ar pressure of the SiN undercoat layer is that the phase pits of the substrate are processed by Ar sputtering. By changing the setup level of the Ar pressure, the plasma status in the film deposition chamber changes, and by this the processing conditions of the phase pits of the substrate surface change. As a result, the adjustment of the modulation degree becomes possible. In other words, the shapes of the phase pits can be substantially processed in the film deposition steps.

FIG. 8 is a graph depicting the modulation degree and the jitter when ROM jitter and MO (RAM) signal jitter on the ROM of the seven magneto-optical disk medium samples, with a modulation degree of 10 (%) to 37 (%) in FIG. 7 were measured, as described above. In FIG. 8, the jitter is used by converting above “data to data” measured value to “clock to data” measured value.

As the modulation degree increases, the MO (RAM) signal jitter on the ROM increases, and as the modulation degree decreases the ROM jitter increases. On the circuit, jitter within the error correction limit is 15% or less, but if the aggravation of jitter by various fluctuation factors, such as disk rotation fluctuation, is considered, then a 10% or less jitter must be implemented.

According to the graph in FIG. 8, the modulation must be set between 16% and 30% to make the jitter of both ROM and MO (RAM) on ROM to be 10% or less. It is even more preferable if the modulation degree is set between 19% and 26% to make the jitter 8% or less.

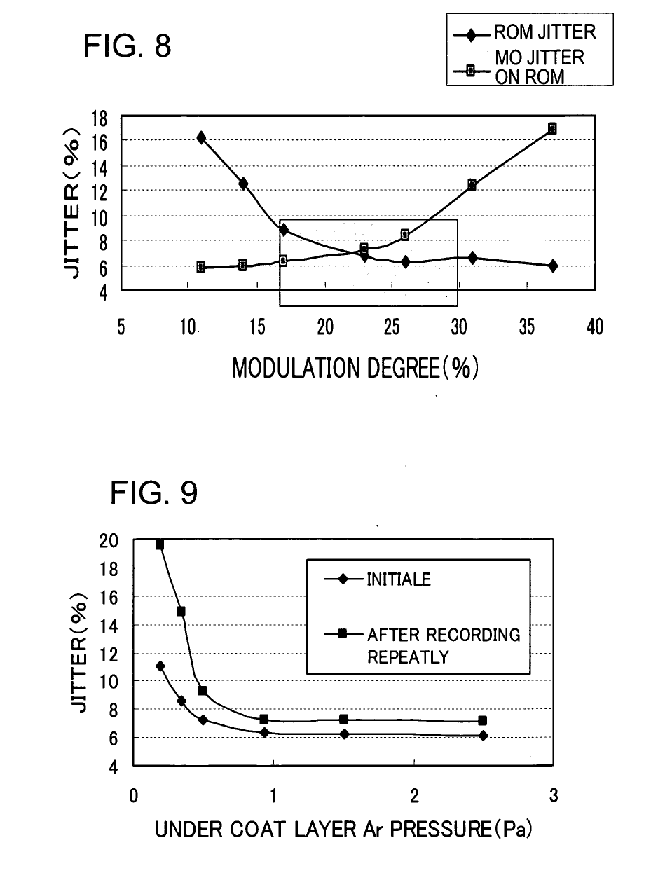

FIG. 9 is a graph depicting the relationship between the jitter of MO (RAM) signals on ROM and Ar pressure when the undercoat layer is formed. For the jitter, the initial jitter and the jitter after 100,000 times of continuous recording testing is performed, were measured.

As FIG. 9 shows, if the Ar pressure is decreased (modulation degree is increased), the jitter of MO (RAM) signals on ROM radically increases, and the jitter of continuous recording also increases as the modulation degree of the ROM regeneration signal increases. As described in FIG. 8, Ar pressure must be set to 0.5 Pa or more to make the jitter after continuous recording to be 10% or less.

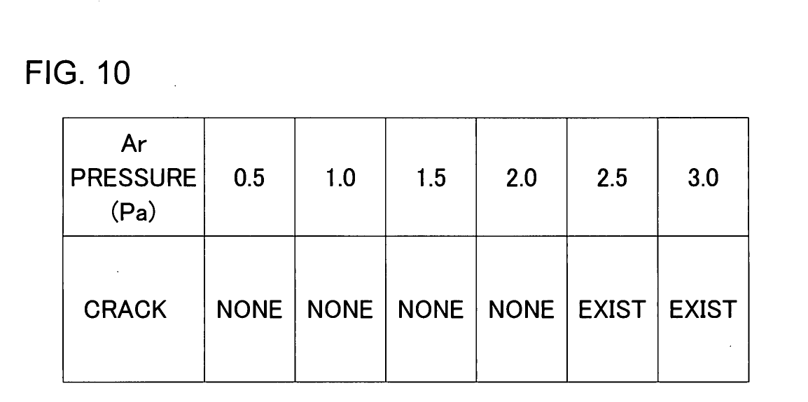

Then a heat shock test is performed on the sample where each layer, including the SiN undercoat layer, are deposited on the substrate 4A, as shown in FIG. 1, then the crack generation of the medium was observed. In other words, as FIG. 10 shows, samples were created with a plurality of Ar pressures to which the SiN undercoat layer was created, and were moved from room temperature to a 100° C. environment and held there for one hour, then were returned to the room temperature environment and crack generation was observed. As FIG. 10 shows, the range where cracks are not generated in the SiN undercoat layer is at Ar pressure 2.0 Pa or less.

As the results in FIG. 8, FIG. 9 and FIG. 10 show, in order to obtain good signal quality for both ROM signals and RAM (MO on ROM) signals without generating cracks, conditions within the frame in FIG. 7 must be met.

For example, in the case of a substrate with a 0.124λ optical pit depth, the Ar pressure is set between 0.7 to 2.0 (Pa). In the case of a 0.080λ optical pit depth, the Ar pressure is set between 0.5 and 1.5 (Pa). And in the case of substrates with a 0.070λ and 0.136λ optical pit depth, the modulation degree cannot be set between 16 and 30% even if the Ar pressure is set between 0.5 and 2.0 (Pa).

In the case of the substrate with a 0.105λ optical pit depth, the modulation degree becomes a range from 16 to 30% with any of 0.5 to 2.0 (Pa) Ar pressure. Conditions with which the jitter of both ROM signals and RAM signals become the optimum is the modulation degree 23%, and with this substrate, an even higher level quality can be implemented by setting the Ar pressure between 0.6 and 1.0 Pa.

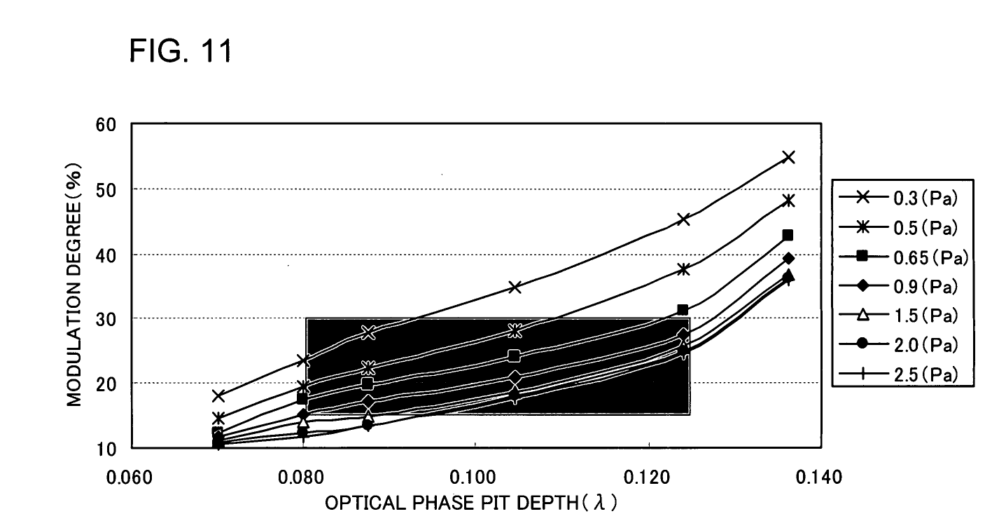

FIG. 11 shows the result when the change of modulation degree with respect to the optical phase pit depth is plotted for each Ar pressure when the under coat SiN is deposited, which is the opposite of FIG. 7. In FIG. 11, when the optical phase pit depth, when the substrate is molded, is 0.080λ the modulation degree can be adjusted in a range of 16 to 30% by adjusting the Ar pressure in the a range of 0.5 to 0.9 (Pa). It is preferable that the modulation degree is adjusted to roughly 19% by setting the Ar pressure to 0.5 (Pa).

Whereas when the optical pit depth is a deeper 0.124λ, the modulation degree in a range of 16 to 30% can be implemented by setting the Ar pressure when the under coat SiN film is deposited at a range of 0.9 to 2.0 (Pa). It is preferable that the modulation degree is adjusted to roughly 26% by setting the Ar pressure to 2.0 (Pa).

When the phase pit depth is at mid-level 0.105λ, a 16 to 30% demodulation degree can be implemented in an Ar pressure range of 0.5 to 2.0 (Pa). It is preferable that a 19-26% modulation degree is implemented by adjusting the Ar pressure in a range of 0.65 to 1.5 (Pa).

When the depth of the optical phase pits becomes shallow, to 0.080λ or less, the adjustable range of the modulation degree becomes narrow, and a 19 to 26% modulation degree cannot be implemented. For phase pits with a 0.124λ or deeper as well, the modulation degree adjustable range becomes narrow, and a 19 to 26% modulation degree cannot be implemented.

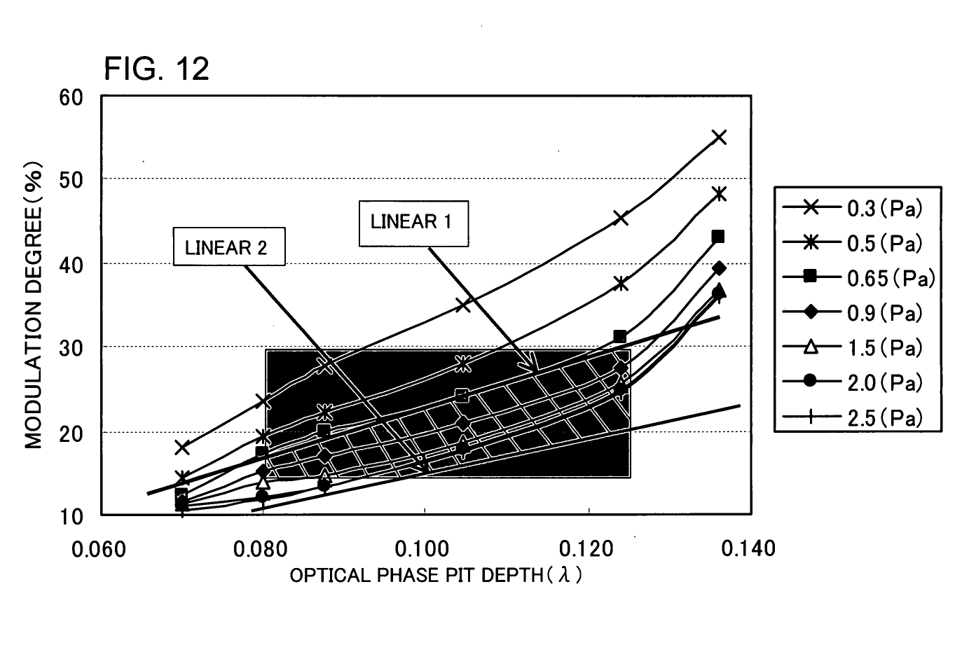

FIG. 12 is a characteristic diagram considering the above mentioned repeat recording characteristics in FIG. 9, and the crack generation in FIG. 10 related to FIG. 11. In other words, FIG. 12 shows the setup range of the phase pit depth and modulation degree with which the magneto-optical medium, which can regenerate ROM and RAM simultaneously where 10% or less of good jitter is implanted for both ROM and RAM signals without generating cracks with sufficient recording durability, can be implemented.

In FIG. 12, line 1 is determined from the repeat characteristics in FIG. 9, and line 2 is determined by the crack observation result of the heat shock test in FIG. 10. Therefore as FIG. 12 shows, the above mentioned setup range is a range between the following two lines 1 and 2, and the optical depth of the phase pits is from 0.080λ to 0.124λ, and the modulation degree is in a range of 16 to 30%, preferable a range of 19 to 26%.

Line 1: Y=344×−8.12

Line 2: Y=286×−10.7

In the present embodiment, the sputtering film deposition steps using SiN was described as an example, but other materials can be used only if it is a material of which the modulation degree can be adjusted. SiO₂, AlN, SiA₁₀, SI₁₀N and TaO, for example, can be used.

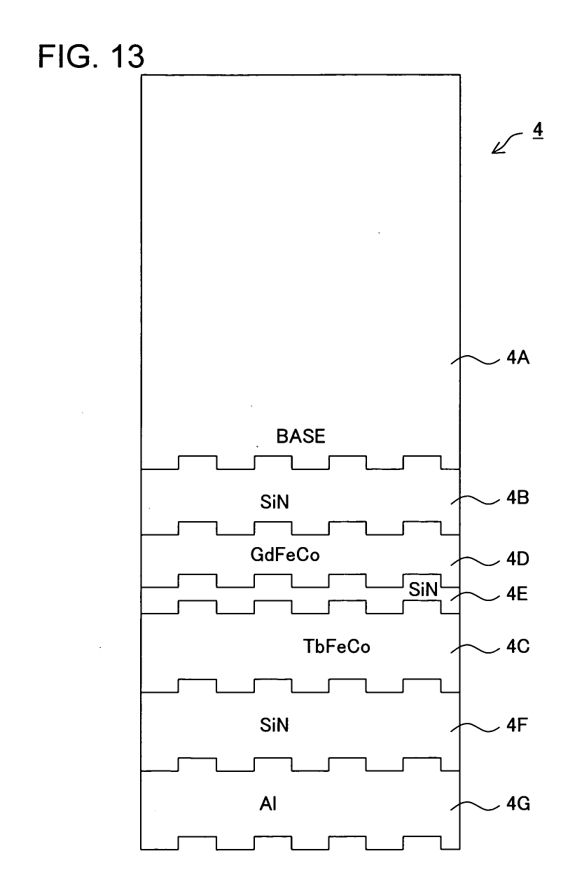

FIG. 13 is a cross-sectional view of the magneto-optical recording medium 4 according to another embodiment of the present invention, and shows the medium for MSR (ultra high resolution recording). The magneto-optical layer formed on the first dielectric layer 4B on the substrate 4A is comprised of the GdFeCo layer (in-plane) 4D, dielectric layer 4E and vertical recording layer (TbFeCo) 4C.

In this recording medium with this configuration as well, the modulation degree of the phase pits can be adjusted by the sputtering film deposition step. The conditions described in FIG. 7 and later on the optical phase pit depth and modulation degree can be used. In the case of MSR, noise cannot be decreased even if the light intensity modulation signals are negatively fed back to the light emitting laser, since the recording density is high, so the effect of the present invention is obvious.

As above described, in a magneto-optical recording medium where a recording film is formed on optical phase pits formed on a substrate so that both the optical phase pit signals and the signals of the recording film can be regenerated by light, following condition is satisfied.
344X−8.12≧Y and Y≧286X−10.7
0.080≦X≦0.124 and 16≦Y≦30
where X (λ) is the optical depth of the phase pits formed on the substrate and Y (%) is the modulation degree of the phase pits when irradiated with an optical beam in the polarization direction perpendicular to the tracks of the optical recording medium.

According to the above condition, a magneto-optical recording medium, which can suppress the jitter of MO signal and phase pit signal within less than ten percents without generating cracks with a sufficient repeat recording durability, is obtained.

Also, it is preferable that the magneto-optical recording medium satisfies the following condition.
344X−8.12≧Y and Y≧286X−10.7
0.080≦X≦0.124 and 19≦Y≦26

According to the above condition, it can suppress the jitter of MO signal and phase pit signal within less than eight percents which has more margin.

Furthermore, it is preferable that above recording film comprises of a dielectric film and a recording film. Furthermore, it is preferable that the dielectric film comprises of SiN, so high durable magneto-optical medium is realized.

Also, it is preferable that the recording layer comprised of a film of which a main component is TeFeCo, and it is further preferable that the recording layer comprises of at least two layers having a layer of which the main component is TeFeCo and another layer of which the main component is GdFeCo and GdFeCo layer is a transition metals rich at room temperature and comprises a vertical magnetic film.

Magneto-Optical Recording Device

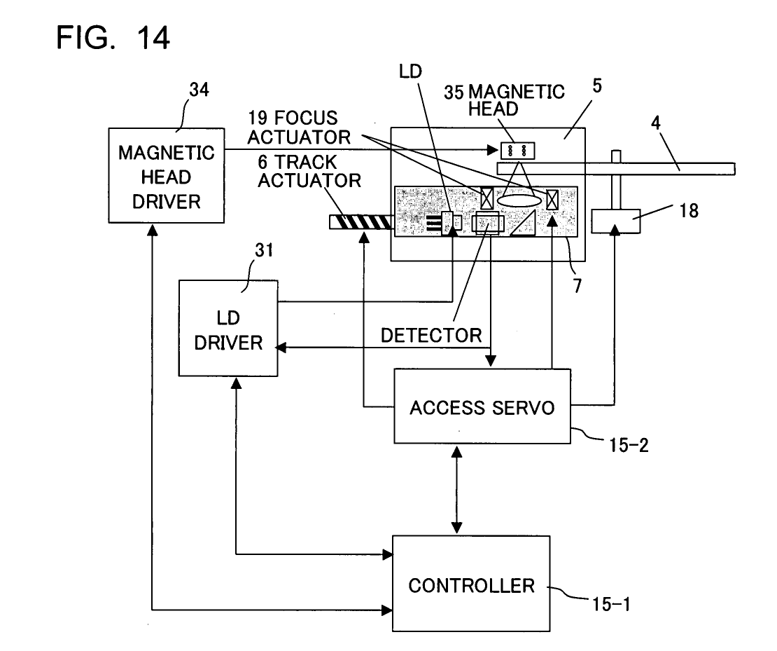

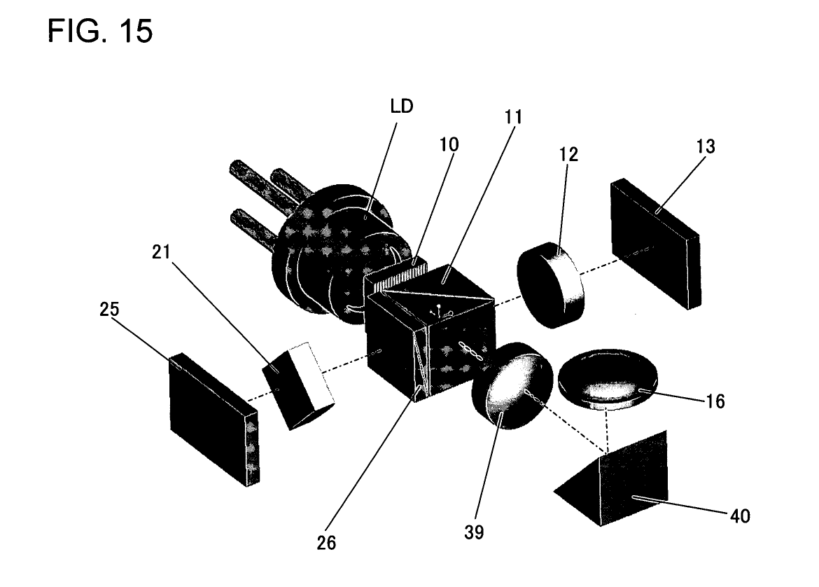

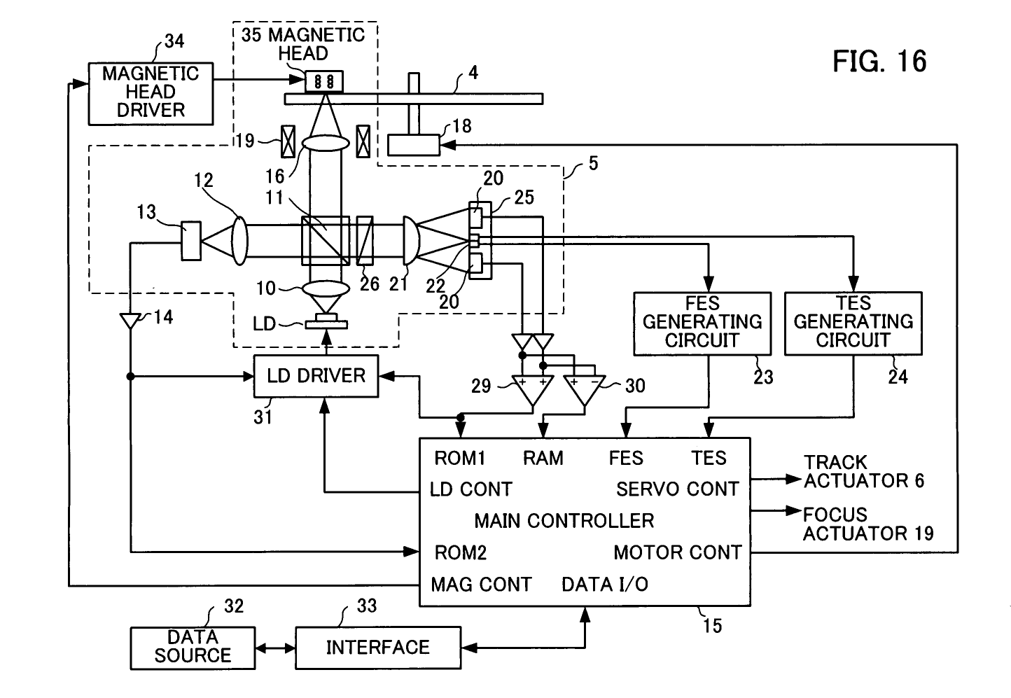

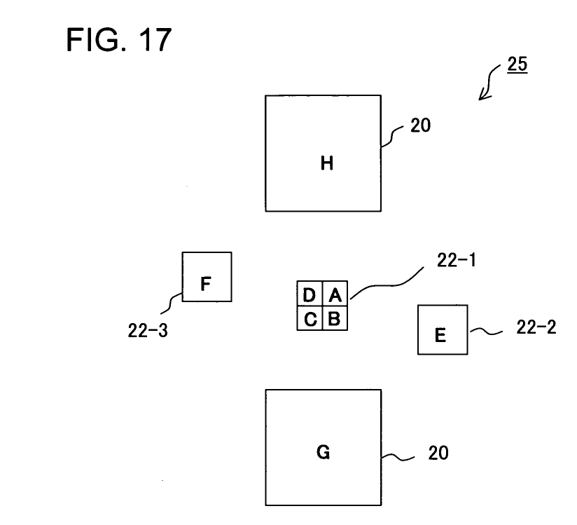

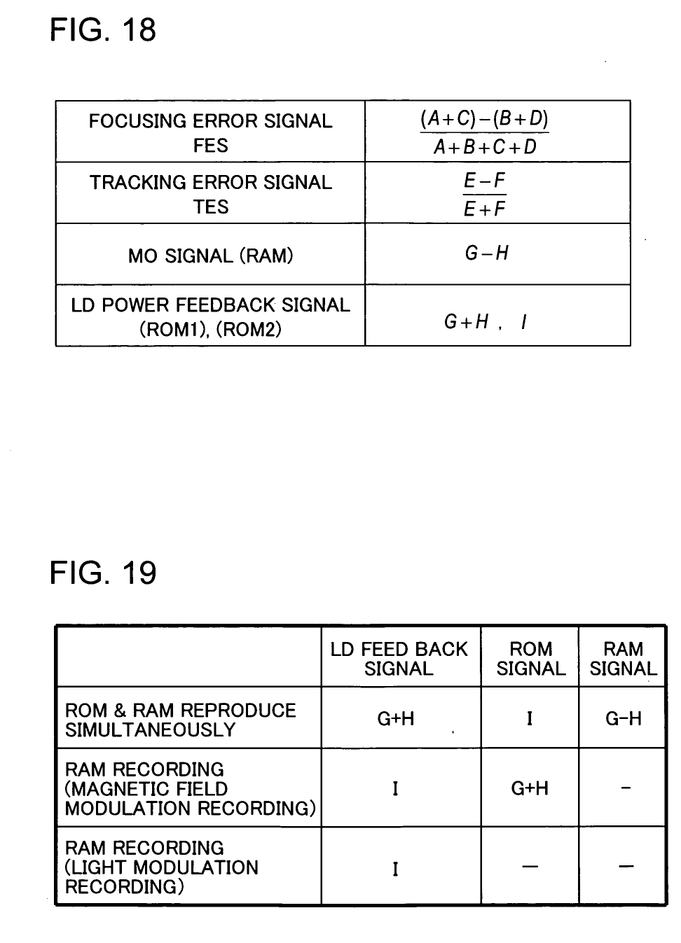

Now the magneto-optical recording device (disk drive) according to the present invention will be described. FIG. 14 is a block diagram depicting the entire optical disk drive according to an embodiment of the present invention, FIG. 15 is a diagram depicting the configuration of the optical system of the drive in FIG. 14, FIG. 16 is a block diagram depicting the signal processing system of the drive in FIG. 14, FIG. 17 is a diagram depicting the arrangement of the detectors in FIG. 15 and FIG. 16, FIG. 18 is a table showing the relationship between the output of a detector and the generation signals, and FIG. 19 is a table describing each mode of the optical disk drive.

As FIG. 14 shows, the spindle motor 18 rotates the magneto-optical recording medium (MO disk) 4. Normally the MO disk 4 is a removable medium and is inserted through the slot of the drive, which is not illustrated. The optical pickup 5 has the magnetic head 35 and the optical head 7, which are disposed so as to sandwich the optical information recording medium 4.

The optical pickup 5 can be moved by the track actuator 6, such as a ball screw feed mechanism, so as to access an arbitrary position on the optical information recording medium 4 in the radius direction. The magneto-optical recording device also has an LD driver 31 for driving the laser diode ID of the optical head 7 and the magnetic head driver 34 for driving the magnetic head 35 of the optical pickup 5. The servo controller for access 15-2 servo-controls the track actuator 6, motor 18 and focus actuator 19 of the optical head 7 according to the output from the optical head 7. The controller 15-1 operates the LD driver 31, magnetic head driver 34 and servo controller for access 15-2 to record/regenerate information.

Details of the optical head 7 will be described with reference to FIG. 15. The diffused lights from the laser diode LD become parallel lights by the collimator lens 39 via the diffraction grating for three-beam tracking 10, the beam splitter 11, and is reflected by the mirror 40, and is condensed on the optical information recording medium 4 by the objective lens 16 almost up to the diffraction limit.

A part of the lights that enters the beam splitter 11 is reflected by the beam splitter 11 and is condensed to the APC (Auto Power Control) detector 13 via the condensing lens 12.

The lights reflected by the optical information recording medium 4 are reflected by the mirror 40 via the objective lens 16 again, become converging lights by the collimator lens 39 and enter the beam splitter 11 again. A part of the lights which reentered the beam splitter 11 return to the laser diode LD side, and the rest of the lights are reflected by the beam splitter 11, and are condensed on the reflected light detector 25 via the three-beam Wollaston prism 26 and cylindrical face lens 21.

Now the shape and the arrangement of the reflected light detector 25 will be described. Since three-beams of lights are entered, the reflected light detector 25 has the four-division detector 22-1, MO signal detectors 20 disposed at the top and bottom thereof, and detectors for track error detection 22-2 and 22-3 which are disposed at the left and right thereof, as shown in FIG. 17.

The regeneration signals will now be described with reference to FIG. 16 and FIG. 18. As FIG. 16 shows, the FES (Focus Error Signal) regeneration circuit 23 detects a focus error (FES) by the astigmatism method shown in FIG. 18 by using the photoelectric converted outputs A, B, C and D of the four-division photo-detector 22. In other words, FES=(A+B)−(C+D)/(A+B+C+D).

At the same time, using the arithmetic expression in FIG. 18, the track error (TES) is detected from the outputs E and F of the detectors for track error detection 22-2 and 22-3 based on the push-pull method in the TES generation circuit 24.
TES=(E−F)/(E+F)

The focus error signals (FES) and the track error signals (TES) determined by these calculations are input to the main controller 15 (servo controller for access 15-2 in the case of FIG. 14) as the position error signals in the focus direction and the track direction. In FIG. 16, the servo controller for access 15-2 and the controller 15-1 are integrated into the main controller 15.

In the recording information detection system, on the other hand, the polarization characteristics of the reflected laser light, which change depending on the magnetization direction of the magneto-optical recording on the optical information recording medium 4, are converted into light intensity. In other words, in the three-beam Wollaston prism 26, the polarization direction is separated into two beams which are perpendicular to each other by polarization detection, the two beams enter the two-division photo-detector 20 through the cylindrical face lens 21, and are photo-electric converted respectively.

The two electric signals G and H, after photo-electric conversion by the two-division photo-detector 20, are added by the addition amplifier 29 according to the arithmetic expression in FIG. 18, and become the first ROM signal (ROM 1=G+H), and at the same time are subtracted by the subtraction amplifier 30 and become the RAM read (MO) signal (RAM=G−H), and both are input to the main controller 15 respectively.

In FIG. 16, the reflected lights of the semiconductor laser diode LD, which entered the photo-detector for APC 13, are photo-electric converted and enter the main controller 15 as the second ROM signal (ROM 2) via the amplifier 14.

Also as described above, the first ROM signal (ROM 1), which is the output of the addition amplifier 29, the RAM signal (RAM 1), which is the output of the differential amplifier 30, the focus error signal (FES) from the FES generation circuit 23, and the track error signal (TES) from the TES generation circuit 24 are input to the main controller 15.

Also the recording data and the reading data are input/output to the main controller 15 via the interface circuit 33 with the data source 32.

The first ROM signal (ROM 1=G+H), the second ROM signal (ROM 2=I) and the RAM signal (RAM=G−H) to be input to the main controller 15 are detected and used according to each mode, that is, ROM and RAM simultaneous regeneration, ROM regeneration, and magnetic field modulation and light modulation RAM recording (WRITE).

FIG. 19 is a table showing the combination of ROM 1 (=G+H) and ROM 2 (=I) and RAM (G−H) in each mode. The main controller 15 generates a command signal for the LD driver 31 according to each mode. According to the command signal, the LD driver 31 performs negative-feedback control of the emission power of the semiconductor laser diode LD based on the first ROM signal (ROM 1=G+H) at ROM and RAM regeneration, and performs negative-feedback control of the emission power of the semiconductor laser diode LD based on the second ROM signal (ROM 2=I) at RAM recording.

At magneto-optical (RAM) recording, data from the data source 32 is input to the main controller 15 via the interface 33 (see FIG. 16). When the magnetic field modulation recording system is used, the main controller 15 supplies this input data to the magnetic head driver 34. The magnetic head driver 34 drives the magnetic head 35 and modulates the magnetic field according to the recorded data. At this time in the main controller 15, the signal to indicate recording is sent to the LD driver 31, and the LD driver 31 performs negative-feedback control for the emission of the semiconductor laser diode LD so as to be the optimum laser power for recording according to the second ROM signal (ROM 2=I).

If the light modulation recording system is used, this input data is sent to the LD driver 31 and drives the laser diode LD for light modulation. At this time in the main controller 15, a signal to indicate recording is sent to the LD driver 31, and the LD driver 31 performs the negative-feedback control for the emission of the semiconductor laser diode LD so as to be the optimum laser power for recording according to the second ROM signal (ROM 2=I).

In the above example, the focusing error signal is detected by the astigmatism method, the tracking error signal is detected by the three-beam method, and the MO signal is detected by the differential detection signal of the polarization component, but the abovementioned optical system is only used for the present embodiment, and the knife edge method of the spot size position detection method, for example, can be used for the focusing error detection method without any problems. For the tracking error detection method, such a method as the push-pull method and the phase different method can be used without any problems.

The main controller 15 (servo controller 15-2 in the case of FIG. 14) drives the focus actuator 19 according to the detected focus error signal FES to perform the focusing control of the optical beam. The main controller 15 (servo controller 15-2 in the case of FIG. 14) also drives the track actuator 6 according to the detected track error signal TES to perform seek and track follow up control of the optical beam.

In this case, the signals G+H of the detector 25 or I of the detector 13 is used for laser power adjustment. When a ROM signal and RAM signal are simultaneously regenerated, as shown in FIG. 19, then laser power is controlled for the signal G+H to be constant, so that the RAM read signal (=G−H) does not receive crosstalk from the phase pit modulation of the magneto-optical recording medium 4. ROM is not detected during light modulation recording.

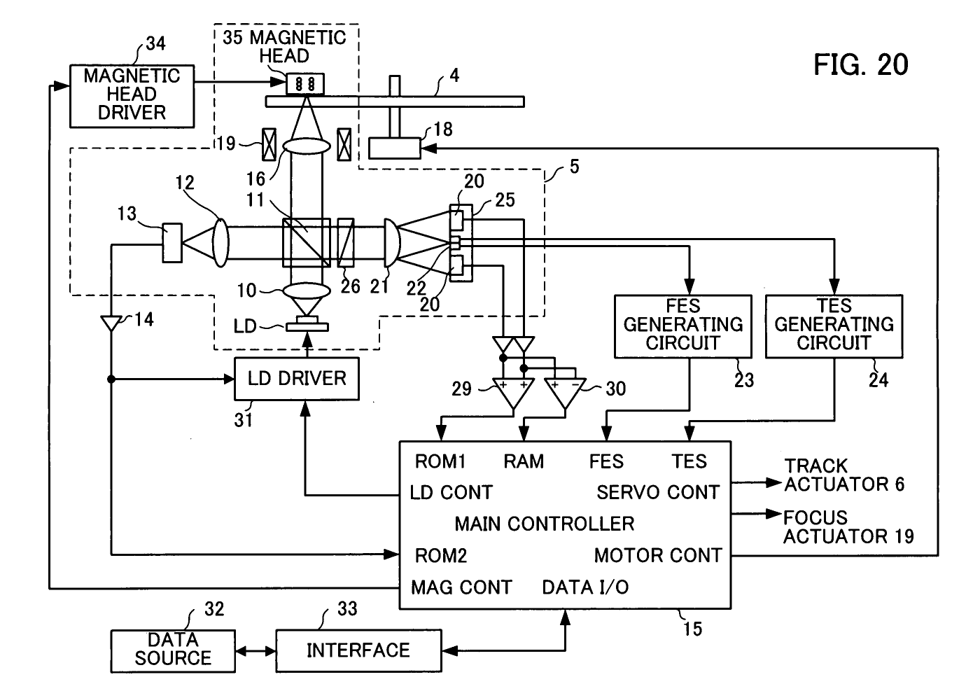

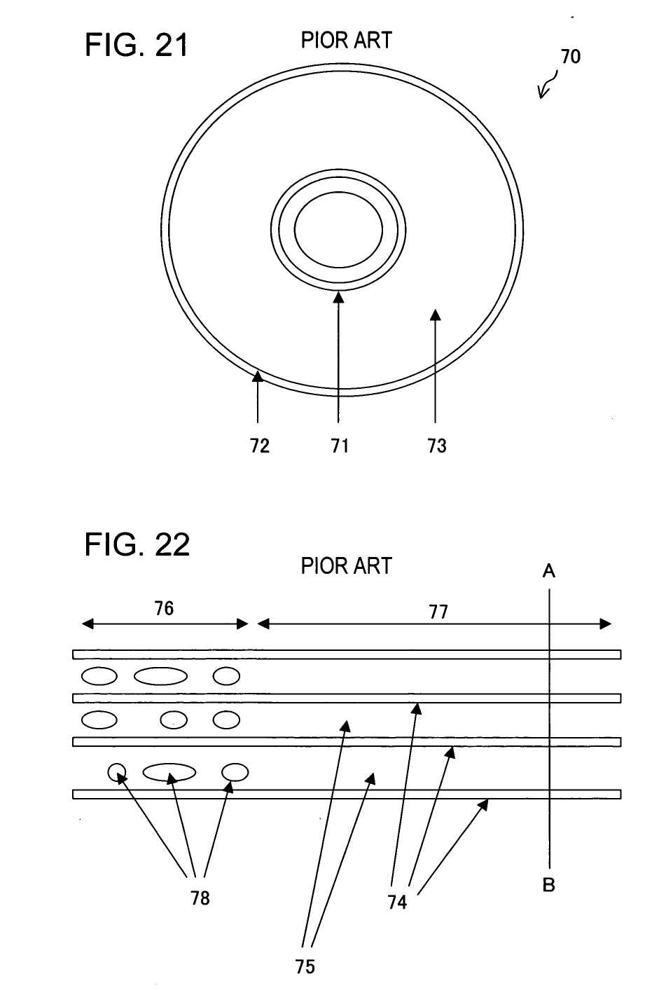

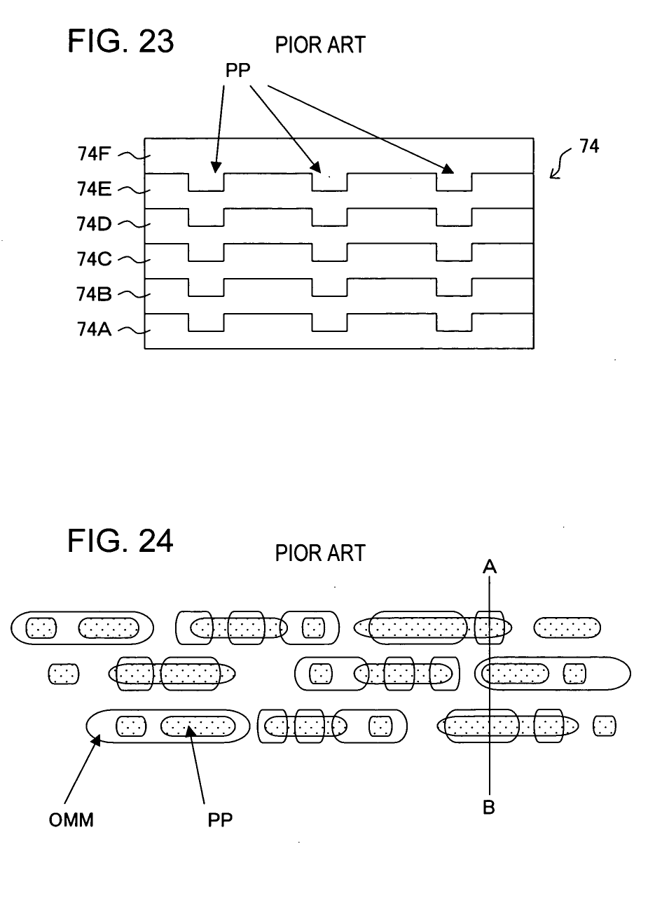

FIG. 20 is a block diagram depicting a magneto-optical recording device according to another embodiment of the present invention. In FIG. 20, composing elements the same as in FIG. 14 to FIG. 16 are denoted with the same reference numerals. In this example, negative-feedback control of the laser diode LD by the ROM 1 signal (phase pit modulation signal) is not performed.

If the abovementioned magneto-optical recording medium 4 is used, noise caused by the phase pit modulation signals can be decreased, so negative-feedback control is unnecessary. Therefore the phase delay of negative-feedback control can be prevented, and therefore this magneto-optical recording medium 4 is particularly suitable for high-speed disk rotation and high density recording.

Other Embodiments

The present invention was described above using embodiments, but the present invention can be modified in various ways within the scope of the essential character of the present invention, and these shall not be excluded from the technical scope of the present invention. For example, the size of the phase pits is not limited to the above numeric values but can be other values. Also for the magneto-optical recording film, other magneto-optical recording material can be used. Also the magneto-optical recording medium is not limited to a disk type but may be a card type or have other shapes.

### INDUSTRIAL APPLICABILITY

In a magneto-optical recording medium where a recording film is formed on optical phase pits formed on a substrate so that both the optical phase pit signals and the signals of the recording film can be regenerated by light, following condition is satisfied.
344X−8.12≧Y and Y≧286X−10.7
0.080≦X≦0.124 and 16≦Y≦30
where X (λ) is the optical depth of the phase pits formed on the substrate and Y (%) is the modulation degree of the phase pits when irradiated with an optical beam in the polarization direction perpendicular to the tracks of the optical recording medium.

According to the above condition, a magneto-optical recording medium, which can suppress the jitter of MO signal and phase pit signal within less than ten percents without generating cracks with a sufficient repeat recording durability, is obtained.

Furthermore, it is realized by the construction of medium, so it is realized easily and stably.

1. A magneto-optical recording medium where a recording film is formed on optical phase pits formed on a substrate so that both the optical phase pit signals and the signals of the recording film can be regenerated by light, satisfy following condition,
344X−8.12≧Y and Y≧286X−10.7
0.080≦X≦0.124 and 16≦Y≦30
where X (λ) is the optical depth of the phase pits formed on the substrate and Y (%) is the modulation degree of the phase pits when irradiated with an optical beam in the polarization direction perpendicular to the tracks of the optical recording medium.

2. The magneto-optical recording medium according to claim 1, satisfies the following condition,
344X−8.1224 Y and Y≦286X−10.7
0. 080≦X≦0.124 and 19≦Y≦26.

3. The magneto-optical recording medium according to claim 1, wherein said modulation degree of said phase pits is defined as a ratio of a reflect level of a space portion which exist no phase pits of the magneto-optical recording medium and a difference between a reflect level of said space portion and a reflect level of a mark portion which exist said phase pit when irradiated with an optical beam in the polarization direction perpendicular to the tracks of said magneto-optical recording medium.

4. The magneto-optical recording medium according to claim 1, wherein said magneto-optical recording film comprises:
a first dielectric layer;
a recording layer;
a second dielectric layer; and
a reflective layer.

5. The magneto-optical recording medium according to claim 4, wherein said first dielectric layer comprises SiN by sputtering.

6. The magneto-optical recording medium according to claim 4, wherein said recording layer comprises a film of which a main component is TeFeCo.

7. A magneto-optical recording device, comprising:
an optical head for irradiating light onto a magneto-optical recording medium where a magneto-optical recording film is formed on a substrate in which the phase pits are formed, detecting the light intensity modulated by said phase pits as ROM signals from the return light from said magneto-optical recording medium, and detecting the differential amplitude of the polarization direction components when said return light is modulated by said magneto-optical recording film as RAM signals;
a magnetic field application unit for applying a magnetic field onto the magneto-optical recording medium for recording on said magneto-optical recording film; and
a track actuator for having at least said optical head access a desired position of said magneto-optical recording medium,
wherein said magneto-optical recording medium satisfies following condition,
344X−8.12≧Y and Y≧286X−10.7
0.080≦X≦0.124 and 16≦Y≦30
where X (λ) is the optical depth of the phase pits formed on the substrate and Y (%) is the modulation degree of the phase pits when irradiated with an optical beam in the polarization direction perpendicular to the tracks of the optical recording medium.

8. The magneto-optical recording device according to claim 7, said magneto-optical recording medium satisfies 19≦Y≦6.

9. The magneto-optical recording device according to claim 7, wherein said modulation degree of said magneto-optical recording medium is defined as a ratio of a reflect level of a space portion which exist no phase pits of the magneto-optical recording medium and a difference between a reflect level of said space portion and a reflect level of a mark portion which exist said phase pit when irradiated with an optical beam in the polarization direction perpendicular to the tracks of said magneto-optical recording medium.

10. The magneto-optical recording device according to claim 7, wherein said magneto-optical recording film of said magneto-optical recording medium comprises:
a first dielectric layer;
a recording layer;
a second dielectric layer; and
a reflective layer.

11. The magneto-optical recording device according to claim 10, wherein said first dielectric layer of said magneto-optical recording medium comprises SiN by sputtering.

12. The magneto-optical recording device according to claim 10, wherein said recording layer of said magneto-optical recording medium comprises a film of which a main component is TeFeCo.
